(19) United States
(12) Patent Application Publication
(10) Pub. No.: US 2020/0241188 A1
(43) Pub. Date: Jul. 30, 2020

(54) OPTICAL DEVICES WITH NANOWIRE GRID POLARIZER ON A CURVED SURFACE AND METHODS OF MAKING AND USING

(71) Applicant: Wostec, Inc., San Francisco, CA (US)

(72) Inventors: Valery Konstantinovich Smirnov, Yaroslavl (RU); Dmitry Stanislavovich Kibalov, Yaroslavl (RU)

(21) Appl. No.: 16/651,097

(22) PCT Filed: Sep. 27, 2017
(86) PCT No.: PCT/RU2017/000714

§ 371 Date: Mar. 26, 2020

(51) Int. Cl. G02B 5/30; G02F 1/1335

(52) U.S. Cl. CPC G02B 5/3058; G02F 1/133528

(57) ABSTRACT

An optical device may include, in order, a first quarter wave plate; a half mirror; a second quarter wave plate; and a curved nanowire grid polarizer. The curved nanowire grid polarizer may include a curved substrate, a non-regular, substantially periodic array of substantially parallel, elongated nanoridges disposed on the curved substrate and having a wave-ordered structure and being oriented along a first direction, and an array of metal nanowires disposed on the array of nanoridges

### FIELD

The invention relates to optical devices that contain a curved nanowire grid polarizer. The invention also relates to methods of making and using the optical devices.

### BACKGROUND

Optical devices, such as virtual reality devices, display images from an image source. These devices often incorporate polarizers.

Wire grid polarizers are widely used in, for example, devices for graphic information imaging (e.g., see U.S. Pat. No. 6,452,724, incorporated herein by reference). The commonly-used technology for manufacturing these devices is based on optical or interference lithography. However, the cost associated with the use of the tools designed for these applications is considered very significant. The existing approach and tools make it difficult to fabricate wire grid polarizers on curved substrates such as spherical or other more complex optical shapes. In addition, the existing approach makes it is very difficult to create wire grid structures with a period of 150 nm or less. While different applications have different requirements, structures with smaller feature size are usually associated with higher performance.

### BRIEF SUMMARY

A variety of optoelectronic and other applications can benefit from efficient methods for forming arrays of nanowires with a period of 150 nm or less on curved surfaces.

To manufacture such structures, a curved hard nanomask is formed by irradiating a curved layer of a first material with an ion flow. The curved hard nanomask may be used in transferring a substantially periodic pattern onto a curved substrate. This nanomask includes a substantially periodic array of substantially parallel elongated elements having a wavelike cross-section and oriented along the lines of intersections of the curved substrate surface with a set of parallel planes. At least some of the elements have the following cross-section: an inner region of first material, a first outer region of a second material covering a first portion of the inner region, and a second outer region of the second material covering a second portion of the inner region and connecting with the first outer region at a wave crest. The first outer region is substantially thicker than the second outer region. The second material is formed by modifying the first material using an ion flow. The substantially parallel, elongated elements having the wavelike cross-section are positioned on the curved layer of the first material along the lines of intersections of the curved layer surface with a set of parallel planes.

In at least some embodiments, the average period of the substantially periodic array is in a range from 20 to 150 nm.

In at least some other embodiments, the curved substrate is a lens having a diameter in a range of 4-200 mm.

Another embodiment is a method of forming a curved hard nanomask for transferring a substantially periodic pattern onto a curved substrate. The method includes depositing a first material to form a curved surface layer on top of a surface of a curved substrate; and irradiating the surface of the curved surface layer with a flow of ions until a curved hard nanomask is formed, the nanomask including a substantially periodic array of substantially parallel elongated elements having a wavelike cross-section and oriented along the lines of intersections of the layer surface with a set of parallel planes, at least some of the elements having the following structure in cross-section: an inner region of first material, a first outer region of a second material covering a first portion of the inner region, and a second outer region of the second material covering a second portion of the inner region and connecting with the first outer region at a wave crest, where the first outer region is substantially thicker than the second outer region, and where the second material is formed by modifying the first material by the ion flow, where the ion flow is arranged so as a local plane of ion incidence is substantially perpendicular to the set of parallel planes and oriented along a local surface normal of the surface layer.

In at least some embodiments, the curved substrate is a lens, during the formation of curved hard nanomask the lens is moved with respect to the ion flow, and the ion flow is shaped to have an ion beam with a size (D1) in the ion incidence plane which is determined by a radius of curvature (R) of the curved lens surface as D1≤R/6 or D1≤R/3.

In at least some embodiments, the first material is silicon and a layer of amorphous silicon containing 5-15 at % of Au is deposited on the surface of the curved layer of silicon prior to ion irradiation and the curved substrate is a lens. During the formation of the curved hard nanomask the lens is moved with respect to the ion flow, and the ion flow is shaped to have an ion beam with a size (D1) in the ion incidence plane which is determined by a radius of curvature (R) of the curved lens surface as D1≤R/2.

In at least some embodiments, the curved substrate is a lens. During the formation of the curved hard nanomask the lens is moved with respect to the ion flow, and the ion flow is shaped to have an ion beam with a size (D2) in the plane perpendicular to the ion incidence plane which is determined by a radius of curvature (R) of the curved lens surface as D2≤R/15.

In at least some other embodiments, the curved substrate is positioned stationary with respect to a specially arranged ion flow.

Another embodiment is an optical device that may include a first quarter wave plate; a half mirror; a second quarter wave plate, where the half mirror is disposed between the first and second quarter wave plates; and a curved nanowire grid polarizer, where the second quarter wave plated is disposed between the half mirror and the curved nanowire grid polarizer. The curved nanowire grid polarizer may include a curved substrate, a non-regular, substantially periodic array of substantially parallel, elongated nanoridges disposed on the curved substrate and having a wave-ordered structure and being oriented along a first direction, and an array of metal nanowires disposed on the array of nanoridges.

In at least some embodiments, the optical device further includes an image source, where the first quarter wave plate is disposed between the image source and the half mirror. In at least some embodiments, the optical device further includes a polarizer disposed between the image source and the first quarter wave plate. In at least some embodiments, a period of the substantially periodic array is in a range from 20 to 150 nm.

In at least some embodiments, the nanoridges are formed by pattern transfer from a curved hard nanomask including a substantially periodic array of substantially parallel elongated elements having a wavelike cross-section and oriented along the first direction wherein, at least some of the elements of the nanomask have the following structure in cross-section: an inner region of first material, a first outer region of a second material covering a first portion of the inner region, wherein the second material is formed by modifying the first material using an ion flow, where the substantially parallel, elongated elements having the wavelike cross-section are formed in a curved layer of the first material deposited on the curved substrate, wherein the first direction is along lines of intersections of a surface of the curved layer with a set of parallel planes and wherein a plane of incidence of the ion flow is substantially perpendicular to the first direction. In at least some embodiments, the pattern transfer includes transferring a pattern of the elongated elements on the nanomask to a surface of a curved mold and using the curved mold to form the array of nanoridges of the curved nanowire grid polarizer.

In at least some embodiments, the curved substrate and the substantially periodic array of substantially parallel, elongated nanoridges disposed on the curved substrate are made of optically transparent polymeric material. In at least some embodiments, the optical device is a virtual reality device. In at least some embodiments, the half mirror is curved. In at least some embodiments, the curved nanowire grid polarizer is convex relative to a viewer using the optical device. In at least some embodiments, the curved nanowire grid polarizer is concave relative to a viewer using the optical device. In at least some embodiments, the half mirror and the second quarter wave plate are disposed together on a lens.

Another embodiment is a method of making a curved nanowire grid polarizer for an optical device that includes depositing a first material to form a curved surface layer on top of a surface of a curved substrate; irradiating the surface of the curved surface layer with a flow of ions until a curved hard nanomask is formed, the nanomask including a substantially periodic array of substantially parallel elongated elements having a wavelike cross-section, at least some of the elements having the following structure in cross-section: an inner region of first material, a first outer region of a second material covering a first portion of the inner region, and a second outer region of the second material covering a second portion of the inner region and connecting with the first outer region at a wave crest, wherein the first outer region is substantially thicker than the second outer region, and wherein the second material is formed by modifying the first material by the flow of ions, wherein the elongated elements are oriented along lines of intersections of the curved surface layer with a set of parallel planes, and wherein the flow of ions is arranged so as a local plane of ion incidence is substantially perpendicular to the set of parallel planes and oriented along a local surface normal of the curved surface layer; transferring a pattern of the elongated elements of the nanomask to a surface of a curved, optically transparent substrate to form a non-regular, substantially periodic array of substantially parallel, elongated nanoridges; and disposing a metal layer on the nanoridges to form an array of metal nanowires of a curved nanowire grid polarizer.

In at least some embodiments, transferring a pattern includes transferring the pattern of the elongated elements on the nanomask to a surface of a curved mold and using the curved mold to form the array of nanoridges of the curved nanowire grid polarizer; and imprinting an optically transparent polymeric material using the curved

[symbol]

FIG. 2A is a perspective view of the arrangement of a curved hard nanomask on a convex spherical surface, according to the invention.

FIG. 2B is a perspective view of the arrangement of a curved hard nanomask on a concave spherical surface, according to the invention.

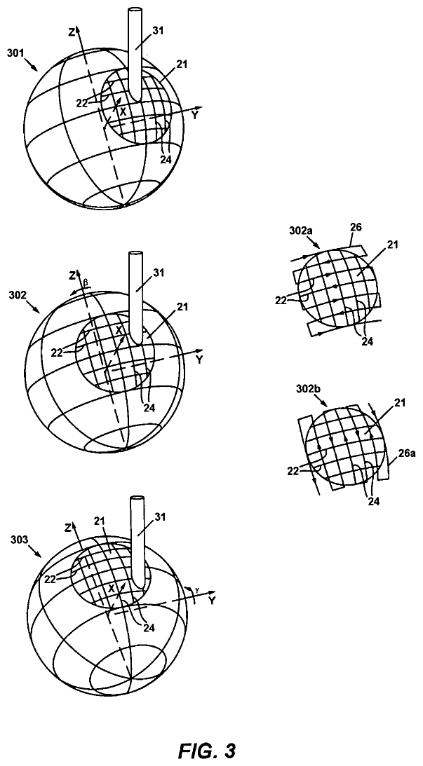

FIG. 3 illustrates perspective views of a fixed ion beam and relative positions of a spherical segment during its movement under the ion beam, according to the invention.

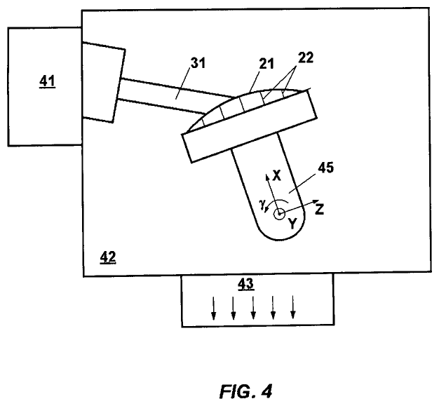

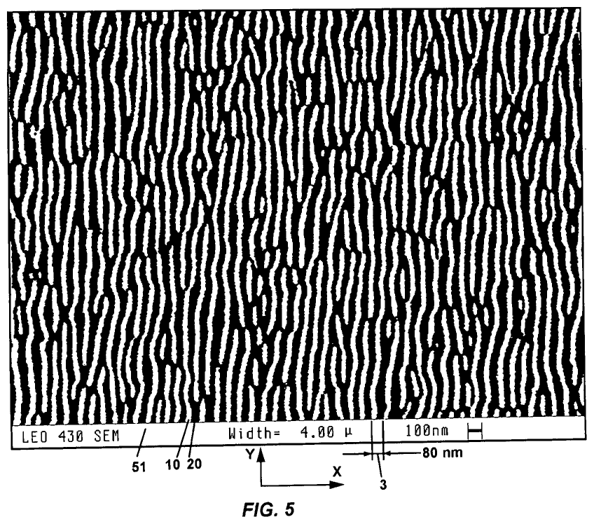

FIG. 4 schematically illustrates an ion beam tool for forming a curved hard nanomask on a moving curved substrate, according to the invention.

FIG. 5 shows a SEM top view image of a curved WOS hard nanomask having a period of 80 nm and radius of curvature of R=60 mm formed on a moving substrate by two-step irradiation of an amorphous silicon layer with a N₂⁺ fixed ion beam of about 5 mm in diameter having energy E=3.7 keV at an angle of bombardment θ₁=44° from surface normal at the first step and at θ₂=60° at the second step, according to the invention.

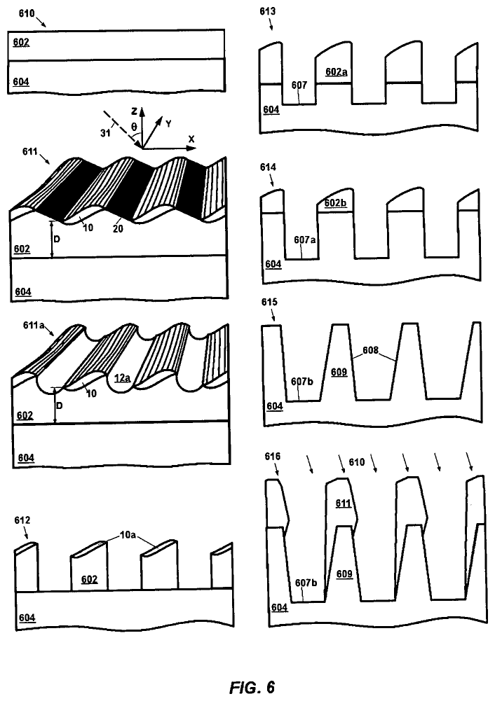

FIG. 6 schematically illustrates steps in one embodiment of a method for formation of a device, such as a wire grid polarizer, using a curved hard nanomask formed in an amorphous silicon layer, according to the invention.

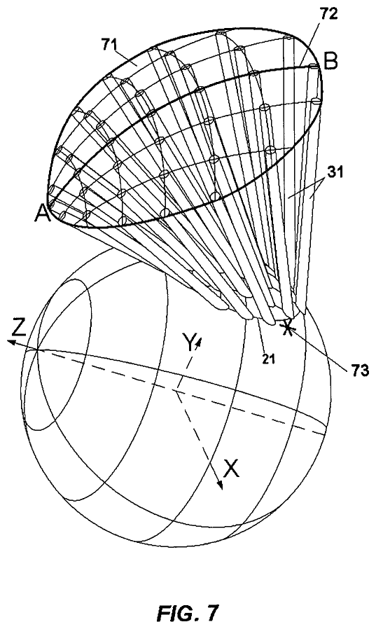

FIG. 7 is a perspective view of a special grid surface of an ion source to manufacture a curved hard nanomask on a fixed curved substrate, according to the invention.

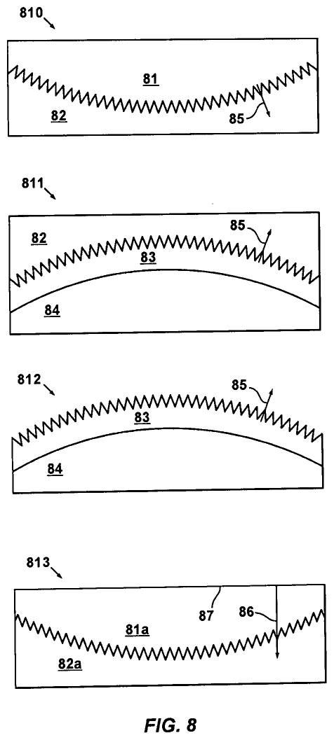

FIG. 8 shows cross-sectional views of polymeric structures with elongated nanoridges formed on curved surfaces formed using nanoimprint lithography, according to the invention.

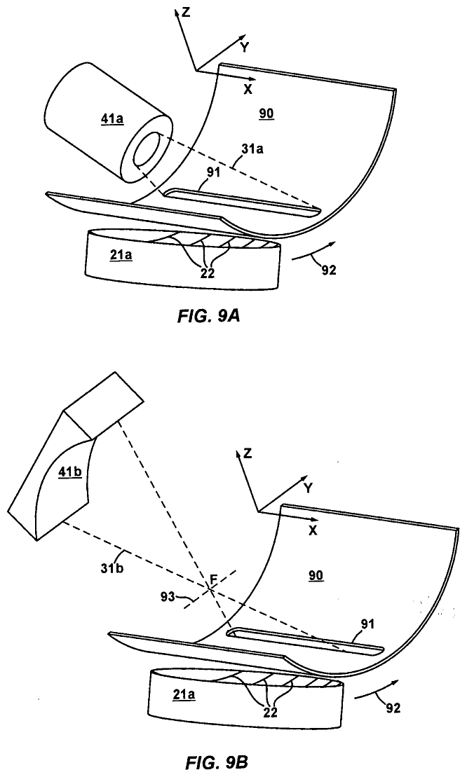

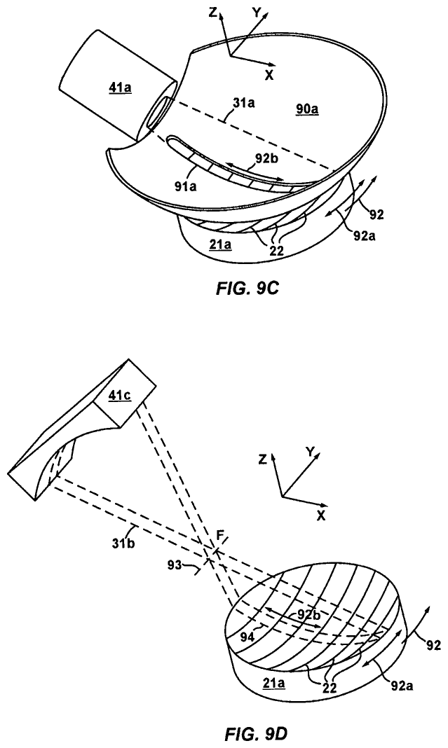

FIG. 9A illustrates a perspective view of a round ion source producing a divergent ion beam, which is shaped by a straight slit in a cylindrical screen, to irradiate a concave spherical substrate during its rotational movement under the slit, according to the invention.

FIG. 9B illustrates a perspective view of a linear cylindrical ion source producing a convergent ion beam, which is shaped by a straight slit in a cylindrical screen, to irradiate a concave spherical substrate during its rotational movement under the slit, according to the invention.

FIG. 9C illustrates a perspective view of a round ion source producing a divergent ion beam, which is shaped by a curved slit in a spherical screen, to irradiate a concave spherical substrate during its rotational movement under the slit, according to the invention.

FIG. 9D illustrates a perspective view of a linear cylindrical ion source producing a convergent, flat ion beam which irradiates a linear stripe area across the surface of a concave spherical substrate during its rotational movement, according to the invention.

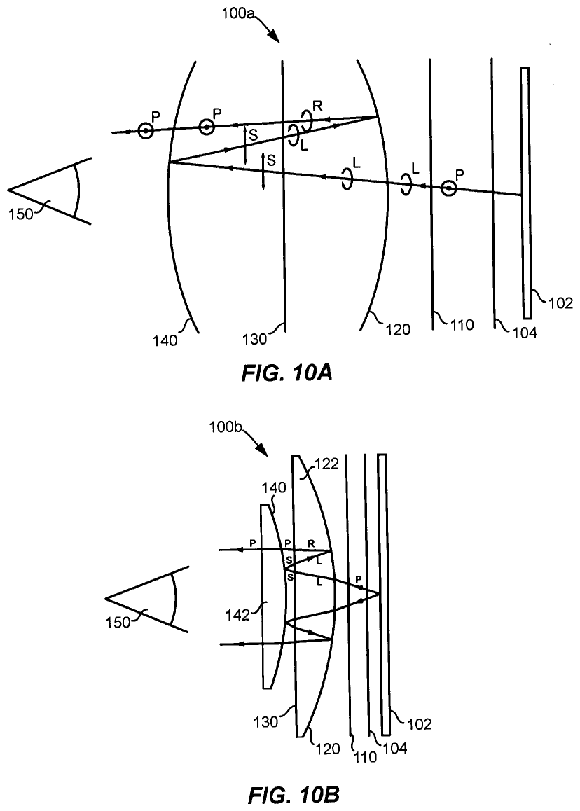

FIG. 10A illustrates one embodiment of an optical device, such as a virtual reality device, according to the invention.

FIG. 10B illustrates another embodiment of an optical device, such as a virtual reality device, according to the invention.

### DETAILED DESCRIPTION

Detailed descriptions of the preferred embodiments are provided herein. It is to be understood, however, that the present inventions may be embodied in various forms. Therefore, specific implementations disclosed herein are not to be interpreted as limiting.

A method for nanorelief formation on a film surface, utilizing plasma modification of a wave-ordered structure (WOS) formed on amorphous silicon layer, was disclosed in Russian Patent Application RU 2204179, incorporated herein by reference.

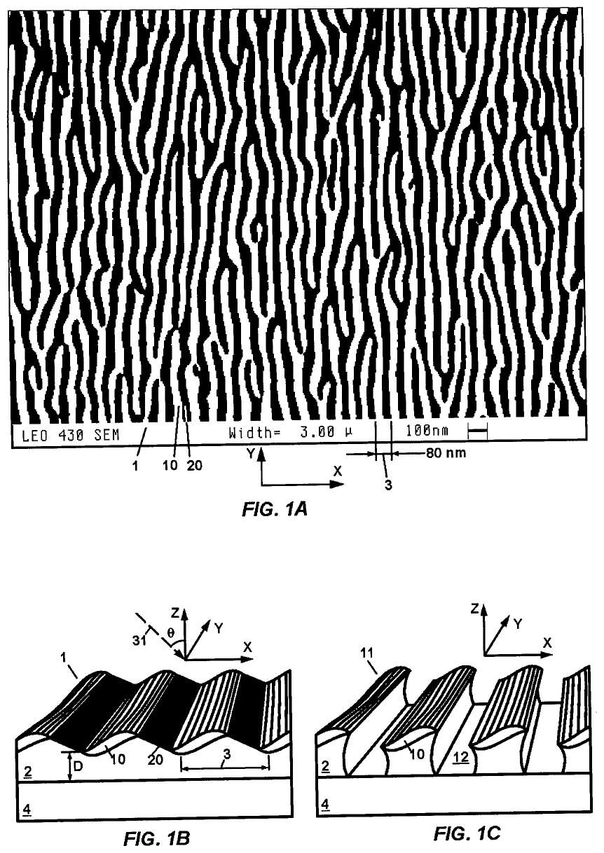

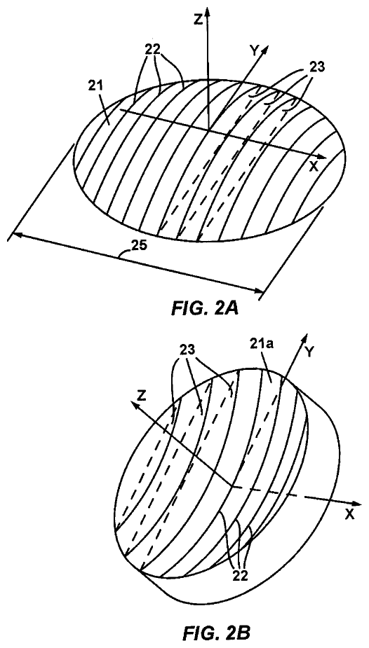

An example of this approach is schematically illustrated on FIGS. 1A, 1B and 1C. First, a layer of amorphous silicon 2 is deposited on top of the target thin film layer 4. Then, the silicon layer is sputtered with a flow of nitrogen ions 31 to create a wave ordered nanostructure 1. The resultant wave-ordered nanostructure has relatively thick regions of amorphous silicon nitride 10 and relatively thin regions of amorphous silicon nitride 20 situated respectively on the front and back sides of the waves in the wave-ordered structure 1. The waves (elements) of the wave-ordered structure are oriented substantially in one direction along one axis. As shown, the wave troughs are spaced from the surface of the film layer 4 by a distance D that is usually less than the nanostructure period 3. After the wave-ordered nanostructure 1 is formed, its planar pattern, which is shown in FIG. 1A, is transferred into the underlying film layer 4 by selectively etching the amorphous silicon layer 2 while using regions 10 and 20 as a nanomask. The intermediate etched structure, which is shown in FIG. 1C as an array of nanostructures 11, is composed from amorphous silicon nanostripes 2 covered by the regions of amorphous silicon nitride 10. The layer 4 may be etched in exposed areas 12 between silicon nanostripes 2.

Ion beam techniques have been used to shape and polish curved optical surfaces through precise material removal by ion sputtering process, as disclosed in Michael Zeuner, Sven Kiontke, Ion Beam Figuring Technology in Optics Manufacturing: An established alternative for commercial applications, Optik & Photonik, Vol. 7, No. 2, 2012, pp. 56-58; and Vladimir Chutko, Ion Sources, Processes, Design Issues: Ion beam figuring, Control Parameters, Vacuum Technology & Coating Magazine, September 2013, pp. 2-10, both of which are incorporated herein by reference. However, these ion beam tools cannot be used directly to form wave-ordered structures on curved surfaces such as, for example, spherical surfaces, with orientation of waves along the latitude lines (parallel lines) on the globe, for fabricating a linear polarizer.

FIG. 2A is a perspective view of a curved hard nanomask on a convex spherical surface. In at least some embodiments, the polarizer substrate is a transparent, spherical segment 21 having a diameter 25, i.e. the diameter of the segment base. The diameter 25 may be in a range of, for example, 4-200 mm. A thin layer of amorphous silicon (a-Si) is deposited onto the spherical segment 21. The elongated elements of a WOS nanomask are positioned along parallel lines 22 (circle arcs), which are lines of intersections of the curved layer surface with a set of parallel planes 23 that, in the illustrated embodiment, are parallel to the YZ plane of a Cartesian coordinate system XYZ. The origin of the coordinate system is positioned at the top of the spherical segment 21.

In at least some other embodiments, the transparent polarizer substrate 21a has a concave spherical surface, as shown in FIG. 2B. On the concave substrate 21a the elements of the WOS nanomask are positioned along parallel lines 22 (circle arcs), which are lines of intersections of the curved a-Si layer surface with a set of parallel planes 23 that, in the illustrated embodiment, are parallel to the YZ plane of a Cartesian coordinate system XYZ. The origin of the coordinate system is positioned at the lowermost point of concave surface of the substrate 21a.

In at least some embodiments, uniform (in terms of density and height) and parallel alignment of the nanomask elements on a spherical surface is achieved through the movement of the substrate under a fixed ion beam as shown in FIG. 3. In 301, the ion beam 31 irradiates the near central area of spherical segment 21. The segment 21 is a part of the sphere. The segment 21 moves under the ion beam along parallel lines 22. In 302, the beam is positioned near the periphery of the segment 21. This segment motion is due to the rotation of the sphere around the Z axis by, for example, an angle β=20°. In at least some embodiments, the segment 21 moves continuously along the lines 22 with a velocity of about 140 μm/s to form one linear stripe of nanomask elements and stops. Then segment 21 makes a step of, for example, about 1 mm for about 0.1 seconds along the line 24 to form the next linear stripe of the nanomask elements along the lines 22 in the opposite direction and so on. This forms a meander scanning pattern 26 which is labeled 302a. The position of the spherical segment 21 in 303 is rotated around Y axis by, for example, an angle γ=20° with respect to the position in 302. In at least some embodiments, the speed of segment movement along lines 22 depends on the ion beam current and the larger the beam current the greater is the speed. For example, the speed of 140 μm/s may correspond to the beam current of about 30 μA and the speed of 4.7 mm/s may correspond to the beam current of about 1 mA. The step movement in the direction along the lines 24 may be, for example, in the range from 0.02 to 0.1 of the ion beam diameter and the smaller the step the faster should be the speed along the lines 22 to keep the ion fluence constant. In some embodiments, the irradiation is implemented using a divergent ion beam with an ion beam incidence angle with respect to the local surface normal of spherical segment that is in the range θ=49°-55°.

In some embodiments with divergent ion beams, another sequence of substrate motion in a meander scanning pattern is implemented. This meander scanning pattern 26a is labeled 302b in FIG. 3. A spherical substrate 21 is moved along lines 24, which are meridians of the globe, and after each line 24 is completed a step along lines 22 is implemented at the periphery of the substrate 21. Ion fluence (dose) is uniformly distributed over the substrate surface at equal local angles of ion incidence. The elements of the WOS nanomask are self-aligned perpendicular to the local ion incidence plane and, in particular for the example illustrated in FIG. 3, the elements of the WOS nanomask are positioned along the lines 22, i.e. along the parallels of the globe.

In at least some embodiments, in the scanning system of FIG. 3, the ion beam may not have a cylindrical shape and may be more extended along meridian lines 24 with a size D1 in the ion incidence plane to cover the range of ion incidence angles from, for example, 44° to 60° and may be narrowed along parallel lines 22 having the size D2 to limit deviation of WOS nanomask elements from the parallel lines 22.

In some embodiments, substrate motion under a fixed ion beam is carried out in a repetitive manner with the ion fluence subdivided between multiple repetitive meander scans 26 or 26a. In this case, the uniformity of ion fluence over the substrate surface may be less dependent on the ion current stability and the greater the number of scans the more uniform is the ion fluence.

In some embodiments, substrate scanning is implemented with a variable, position-dependent speed along lines 22 and 24 of FIG. 3 to compensate for spherical distortions of the rectangular meander patterns 26 and 26a and to obtain uniform ion fluence distribution over the surface of the spherical substrate 21. For example, the lines 22 are arcs with different radii and the radius decreases from the segment center to its periphery. In the meander pattern 26, the arcs are along the lines 22 and constant angular speed for all lines results in smaller fluence at the segment center and larger fluence at peripheral lines 22. To compensate for this fluence nonuniformity the segment 21 can be moved at greater angular speed along peripheral lines 22 in, for example, reverse proportion to the arc radius.

The formation of a curved WOS nanomask was implemented in an ion beam system, which is schematically illustrated in FIG. 4. The system includes a vacuum chamber 42, a pump system 43, and a gridded ion source 41, which forms the ion beam 31. A moving mechanism 45 enables rotation of the spherical segment 21 around the Z axis and the Y axis. Elements of a curved WOS nanomask are aligned substantially parallel along the lines 22.

On the spherical surface, the larger the beam size (D2) in the plane perpendicular to the ion incidence plane, the greater is the deviation of the WOS nanomask elements from the lines 22 of FIG. 3 at both of the most distant, opposite beam edges crossing line 22. To decrease such a deviation and to enhance the alignment of the WOS nanomask elements substantially parallel to the lines 22, in some embodiments, during the formation of the curved WOS nanomask, the spherical substrate is moved with respect to an ion beam having a size D2 which is determined by the radius of substrate curvature (R) as D2≤R/15.

In some embodiments, the spherical segment is a lens having a radius R of the curvature of the external surface. The collimated ion beam, depending on its diameter, has different angles of ion incidence θ across the beam on the curved surface. In some embodiments, the variation of θ in the ion incidence plane may be within the range θ=44°-60° and the ion beam size D1 in the ion incidence plane is limited to D1≤R/6. Taking into account the ion dose dependence of the WOS formation process, this ion beam size restriction may be relaxed. In at least some embodiments, the ion beam size D1 is limited by the surface curvature radius R to D1≤R/3.

In some embodiments, to accelerate the WOS formation process, a gold-containing film is deposited onto the amorphous silicon layer prior to ion irradiation. In some embodiments, the gold-containing film has a thickness in the range of 10 to 25 nm. It has been found that a gold-containing film deposited onto a silicon surface may greatly reduce the time of WOS formation process under nitrogen ion bombardment. Au⁺ ions implanted into monocrystalline silicon at the energy of 12 keV and fluence 1016 cm⁻² accelerated the WOS formation process by about a factor of two for N₂⁺ ions with E=8 keV and an angle of ion incidence of θ=45°. It is noteworthy that Au implantation did not result in any topographical roughness. Thus, the presence of gold in a surface silicon layer can result in the acceleration of WOS formation. It was also found that the acceleration effect is often angular dependent and may be greater for N₂⁺ ion incidence angles of θ=41°-43° whereas almost no acceleration is observed for θ=55°-60°. The nature of angular dependence of WOS formation acceleration may make WOS formation depth almost independent for θ in the range of θ=41°-60°, which means that the ion beam size restriction in scanning system may be further relaxed. In at least some embodiments, on the basis of these observations the ion beam size D1 in the ion incidence plane is related to the substrate surface curvature radius R by D1≤R/2.

In some embodiments, a composite Si—Au layer, 10-40 nm thick, with Au content ranging from 5-15 at % is deposited on the surface of an amorphous (a-Si) layer prior to N₂⁺ ion irradiation. The Si—Au layer may be deposited, for example, by magnetron sputtering using a two-component Si/Au target, in which the silicon wafer is used as a mask with through holes leading to a closely attached Au wafer. For this two-component target with masked Au surface the Au content in the deposited Si—Au film is related to the amount of exposed gold area and by sputtering rates of Au and Si in the particular magnetron sputtering system.

In some embodiments, depending on beam focusing, the substrate (lens) diameter 25 shown in FIG. 2A may be in the range 4 to 200 mm.

FIG. 5 shows a SEM top view image of a curved WOS hard nanomask having a period of 80 nm formed by two-step irradiation of an amorphous silicon layer with N₂⁺ ions having energy E=3.7 keV at an angle of bombardment θ₁=44° from surface normal at the first step and at θ₂=60° at the second step. During the irradiation, the curved substrate was moved under a fixed ion beam having a diameter of about 5 mm. The substrate curvature radius was R=60 mm.

FIG. 6 illustrates one embodiment of a method to manufacture a curved wire grid polarizer or other device on a transparent quartz spherical substrate. It shows a structure 610, including a substrate (e.g., quartz) 604 and a layer of amorphous silicon 602 (for example, approximately 200-400 nm thick).

The amorphous silicon layer 602 may be deposited onto the curved substrate surface, for example, by magnetron sputtering of a silicon target, by silicon target evaporation with an electron beam in high vacuum, or by any other method known in art. The thickness of the layer 602 is selected to enable the formation of a nanostructure with desired period, λ, (for example, a period of approximately 70-90 nm).

A curved WOS is formed on the surface of substrate 604, which results in the structure 611. In this example, the curved WOS is formed using an oblique ion beam 31 of nitrogen N₂⁺ ions positioned at the local ion incidence plane XZ (the plane which is defined by a local normal to the surface of the material and a vector oriented in the direction of the ion flow) at angle θ to the surface normal (Z-axis). In this particular example, to reduce the number of intersections of WOS nanomask elements (waves), the nitrogen ion bombardment is implemented in two steps with different bombardment angles θ. At the first step θ=44° and at the second step θ=60°. The ion energy for both steps is approximately equal to 3.7 keV. The ion fluence for the first step is approximately ten times greater than that for the second step. The resultant WOS nanomask having a period of 80 nm is shown in FIG. 5. The thick silicon nitride regions 10 and thin silicon nitride regions 20 on the opposite slopes of the waves are mostly elongated in the Y-axis direction. As shown in the structure 611, the wave troughs are spaced from the quartz substrate surface 604 by a distance D, which in a given particular example was of about 60 nm.

Depending on the chosen thickness of the modified layer 20 on the back side of waves of the wavelike nanostructure, a preliminary breakthrough etching step might be performed using argon ion sputtering or sputtering by ions of etching plasma for a relatively short period of time to remove the modified layer 20 from the back side. To remove regions 20 one can also perform wet etching in HNO₃—HF solution for a short period of time.

In at least some embodiments, the structure 611 may be optionally wet-etched to form the structure 611a having nanotrenches 12a in place of regions 20. This optional wet etching may improve further etching steps in plasma.

The curved WOS and nanostructures formed from the curved WOS by etching with the use of regions 10 and 20 as a nanomask can be characterized as a quasi-periodic, anisotropic array of elongated ridge elements having a WOS pattern, each ridge element having a wavelike cross-section and oriented substantially in one direction (Y-axis). An example of the pattern of a WOS is shown in FIG. 1A, and an example of the pattern of a curved WOS is shown in FIG. 5. Ridge elements may be waves or other features having tilted tops or sidewalls. In the wave nanostructure 1 of FIG. 1B, the ridge elements are waves with regions 10 and 20 on opposite wave slopes. In the nanostructure 11 of FIG. 1C, the ridge elements are stripes covered by tilted regions 10 and spaced by trenches 12. One can see that the ridge elements are elongated and mostly oriented in the direction of the Y-axis as shown in FIGS. 1A and 5.

Referring again to FIG. 6, the structures 611 or 611a can be modified by applying a reactive-ion plasma (Cl₂, Cl₂—Ar, HBr—O₂ or Cl₂—He—O₂ or by any other method known in art) to the amorphous silicon layer 602, using the curved nanomask having regions 10 of silicon nitride. In at least some embodiments, the process results in a modified nanomask having silicon nitride regions 10a formed on top of stripes of amorphous silicon 602, as shown in the structure 612 of FIG. 6. The thickness of regions 10a may become thinner than the thickness of original regions 10 during plasma etching.

In the next step, anisotropic etching is applied to the substrate 604. Depending on the type of the substrate material, different types of plasma can be used (for example, for a quartz substrate, CF₄—H₂, CHF₃, C₄F₆—Ar or C₄F₈—Ar based plasma can be used). The resulting structures 613-615 may include trenches 607, 607a, and 607b. During etching the amorphous silicon stripes 602 may be modified by plasma to the structures 602a and 602b or may be fully etched, which may result in tilted sidewalls 608 of quartz nanoridges 609. In some embodiments, the structure 612 is modified by ion sputtering using a N₂⁺ ion beam directed along the ridge elements 602 in the YZ ion incidence plane at an angle of, for example, about 53° to the Z axis. The resultant quartz nanoridges have a sawtooth triangular profile with sharp bottoms and tops as shown in FIG. 8. The pattern of nanoridges arising from the etching processes is transferred from the curved WOS hard nanomask.

Oblique deposition of aluminum can be performed on the array of quartz nanoridges as shown in the structure 616 to produce a curved wire-grid polarizer. For uniform deposition, the curved substrate may be moved under the flow of metal atoms 610. In some embodiments, special masks may be applied across the flow of metal atoms to obtain a uniform (in terms of density and height) array of metal nanowires 611 disposed over the nanoridges 609. The array of metal nanowires is substantially periodic, but is also non-regular in that the nanowires are not arranged in a regular array of nanowires. In some embodiments, the mask may include a slit. During the aluminum deposition, the slit mask is positioned along the quartz nanoridges, and the quartz substrate is rotated under the mask in a direction perpendicular to the mask extension for uniform aluminum deposition to the nanoridges.

In at least some embodiments, a curved hard WOS nanomask may be manufactured on fixed spherical substrates by a gridded ion source having a special grid surface, which is shown in FIG. 7. The grid 71 provides microbeams 31 that irradiate the surface of the spherical segment 21 with the same local incidence angle (for example, in the range θ=49°-55°). The surface of grid 71 may be constructed from an arc circle AB 72 having a center 73 (the quasi focus of the microbeams in ZY plane). The surface of the grid 71 may be produced through the rotation of the arc 72 around the Z axis thus forming the surface of revolution to which each microbeam is normal. The border of the surface of the grid 71 is determined by the microbeams positioned at the border of the spherical segment. In at least some embodiments, the grid 71 may be used to shape the ion flow for manufacturing the curved WOS nanomasks on fixed spherical substrates. In at least some embodiments, the complex grid shape is approximated by a spherical shape.

In at least some embodiments, the spherical surface of a quartz substrate with quartz nanoridges may be used as a master mold to transfer a nanoridge pattern to the surface of a curved polymeric substrate. It will be recognized that materials other than quartz can also be used for the substrate and nanoridges. In at least some embodiments, the spherical surface of a silicon substrate with silicon nanoridges may be used as a master mold to transfer a nanoridge pattern to the surface of a curved polymeric substrate. In some embodiments, the master mold has a convex surface. In some other embodiments, the master mold has a concave surface. In some embodiments, the nanoridge pattern of the silicon master mold is transferred into the surface of a nickel thin layer using, for example, nickel electroless plating onto the silicon mold surface and then a thick nickel layer is electrodeposited to make a nickel mold.

In structure 810 of FIG. 8 the quartz master mold 81 with nanoridges on its surface is used to transfer the nanoridge pattern into the surface of an intermediate hard polymeric mold 82 of, for example, polycarbonate. In structure 811 of FIG. 8, the intermediate hard polymeric mold 82 is applied to the UV curable surface layer 83 on the surface of the polymeric substrate 84 during the process of soft nanoimprint lithography as known in the art. In structure 812 of FIG. 8, the resultant nanoridge pattern is formed on the surface layer 83, which is positioned on the polymeric substrate 84. In structure 812 the sidewalls of each nanoridge may be positioned symmetrically with respect to the local surface normal 85. In structure 813 of FIG. 8, the sidewalls of each nanoridge on the surface of master mold 81a may be positioned symmetrically with respect to the normal 86 to the mold base 87. This symmetrical nanoridge orientation allows the printing of higher nanoridges into the surface of a replica 82a compared to the oblique nanoridges in the structures 810, 811, and 812 of FIG. 8. The oblique deposition of metal onto the polymeric nanoridges results in a curved wire-grid polarizer.

In at least some embodiments, the formation of a WOS nanomask on a concave substrate is carried out by linear ion flow to irradiate a linear stripe area on the substrate surface. FIG. 9A shows one arrangement with a round ion source 41a generating a divergent ion beam 31a, which is directed to a straight slit 91 in a cylindrical screen 90. The ion source 41a may be, for example, a gridded ion source. The divergent ion beam 31a irradiates a concave substrate 21a through the slit 91 thus irradiating a linear stripe area on the substrate surface. To irradiate the surface of the substrate 21a, the substrate is rotationally moved around the X axis under the slit 91 in the direction 92. The slit 91 is extended along the X axis and the ion incidence plane coincides with the XZ plane. The parallel lines 22, along which the elements of WOS nanomask are oriented, are perpendicular to the ion incidence plane during ion bombardment and rotational motion of the substrate 21a under the slit 91. The axis of cylinder screen 90 coincides with the X axis and the center of surface curvature of the substrate 21a is at the origin of the XYZ Cartesian coordinate system. The oblique position of the divergent ion beam 31a with respect to the concave substrate 21a and to the slit 91 provides approximately equal local angles of ion incidence along the irradiated linear stripe area of the substrate surface.

In comparison with the arrangement shown in FIG. 4 where the substrate is rotated around two axes, during ion irradiation in the arrangements shown in FIGS. 9A-9D the substrate is rotated only around the X axis and the substrate motion system is simplified.

The arrangement shown in FIG. 9B differs from that shown in FIG. 9A in that the ion source 41b is a linear cylindrical ion source generating a convergent ion beam 31b having a crossover at focal line 93, which is parallel to the Y axis. The ion source 41b may be, for example, a gridded ion source with a cylindrical grid.

In the arrangement shown in FIG. 9C a curved slit 91a in a spherical screen 90a is used in place of the straight slit 91 in the cylindrical screen 90 shown in FIGS. 9A and 9B. In FIG. 9C the centers of surface curvature of the spherical screen 90a and the concave substrate 21a coincide and are located at the origin of the XYZ Cartesian coordinate system. The curved slit 91a extends along the ZX plane thus forming the ion flow in the same ion incidence plane. The arrangement shown in FIG. 9C may provide more uniform irradiation of the substrate because the distance between the substrate 21a and the curved slit 91a is constant whereas that distance varies in the case of the straight slit 91 of FIGS. 9A and 9B. However, the straight slit in a cylindrical screen is simpler to manufacture.

In the arrangement shown in FIG. 9D the irradiation of the linear stripe area 94 on the surface of the substrate 21a is provided directly by a convergent ion beam 31b generated by a cylindrical ion source 41c. The ion beam 31b has crossover at focal line 93, which is parallel to the Y axis. In at least some embodiments, the uniform fluence on the substrate surface is provided through the appropriate variation of ion beam intensity across the ion source or through slit width variation in the screens 90 and 90a.

In at least some embodiments, in the arrangements shown in FIGS. 9C and 9D, during ion irradiation the substrate 21a is rotationally moved in two directions, first direction 92a around the X axis and second direction 92b around the Y axis, to provide uniform ion fluence on the substrate surface. The substrate motion may be one or multiple meander scans.

The curved nanowire grid polarizers formed with the pattern transfer from the WOS nanomask, as described herein (for example, as described with respect to the embodiments illustrated in FIG. 8), can be used in a variety of optical devices. These curved nanowire grid polarizers have a non-regular, substantially periodic array of substantially parallel, elongated nanoridges disposed on the curved substrate and having a wave-ordered structure and being oriented along a first direction. A metal layer is disposed on the nanoridges to form an array of nanowires.

FIG. 10A illustrates one example of an optical device 100a. This optical device 100a can be, for example, a virtual reality device. The optical device 100s includes an image source 102, an initial polarizer 104, a first quarter wave plate 110, a half mirror 120, a second quarter wave plate 130, and a curved nanowire grid polarizer 140 formed using pattern transfer from the curved WOS nanomask. Any of the methods and WOS nanomasks described above can be used to make the curved nanowire grid polarizer. For example, oblique deposition of metal onto the polymeric nanoridges formed using any of the curved WOS nanomask described above can result in the curved nanowire grid polarizer.

In the illustrated embodiment of FIG. 10A, the half mirror 120 is curved. Using a curved half mirror 120 with a curvature in the opposite direction as the curved nanowire grid polarizer 140 can result in a shorter focal length of the optical arrangement making a more compact device. The curvatures of the half mirror 120 and the curved nanowire grid polarizer 140 can be determined to achieve desired device parameters. Such a determination can be made by experimentation, modeling, or any other suitable technique or any combination thereof. One example of device parameters is a diagonal field-of-view of 100 degrees, an exit pupil of 12 mm, an eye relief (distance from the eye cornea to the nearest optical surface) of 20 mm, diagonal size of the image source of 40 mm, a half mirror diameter of 60 mm, and a focal distance (from the image source 102 to the curved nanowire grid polarizer 140) of 17 mm. These is one example of suitable parameters, but other sets of parameters can be used.

In at least one embodiment, light from an image source 102 passes through an initial polarizer 104 to provide linearly polarized light having P-polarization (perpendicular to the drawing sheet). Any suitable image source 102 can be provided including, but not limited to, LED, LCD, or OLED devices. Any suitable polarizer 104, including, but not limited to, reflective or absorptive polarizers, may be used to initially polarize the light. Optionally, arrangements that recycle any light reflected by the initial polarizer 104 may also be used.

As illustrated in FIG. 10A, the P-polarized light passes through the first quarter wave plate 110 and becomes left circularly polarized. Transmission through the half mirror 120 retains the light polarization. Passing through the second quarter wave plate 130 transforms the left circularly polarized light into linear polarized light having S-polarization (parallel to the drawing sheet). This S-polarized light reflects from the curved nanowire grid polarizer 140 back to the second quarter wave plate 130 which then changes the polarization into left circularly polarized. Next reflection from the half mirror 120 transforms the left circular polarization to right circular polarization and after transmission again through the second quarter wave plate 130 the light returns to the initial P-polarization and goes through the curved nanowire grid polarizer 140 to the viewer's eye 150.

Any suitable quarter wave plates 110, 130 can be used. Preferably, the half mirror 120 has approximately 50% reflection and 50% transmission which reduces the light transmission to the viewer to no more than 25% of the original intensity due to two interactions of the light with the half mirror. Naturally, the curved nanowire grid polarizer 140 will further reduce the intensity of light. The curved nanowire grid polarizer 140 formed from the WOS nanomask, as described herein, is highly reflective (particularly when compared to conventional linear reflective polarizers) and, at least in some embodiments, will produce a light transmission of up to 20% or more of the original intensity. In some embodiments, the curved nanowire grid polarizer 140 is convex relative to the viewer's eye 150m as shown in FIG. 10A. In other embodiments, the curved nanowire grid polarizer 140 is convex relative to the image source as shown in FIG. 10B.

FIG. 10B illustrates another example of an optical device 100b. It differs from the device 100a shown in FIG. 10A in that it includes lenses 122, 142, a half mirror 120 is disposed on the surface of the lens 122, and a curved nanowire grid polarizer 140 that is convex toward the image source 102 and disposed on the surface of the lens 142. The polarization states of the light are the same as in FIG. 10A. The combination of reflective and refractive components makes it possible to compensate for spherical aberrations. However, in some embodiments aspherical lenses and mirrors may be used. In at least some embodiments, it is preferable to make lenses from polymeric optical transparent materials. Such polymeric lenses may be used as substrates for curved nanowire grid polarizers.

The high reflectivity (relative to conventional linear reflective polarizers) of nanowire grid polarizer 140 formed from the WOS nanomask, as described herein, can reduce the unwanted reflections in optical device which can produce higher image contrast.

In addition, the curved surface of the nanowire grid polarizer 140 can considerably widen the field of view for the optical device when compared to flat polarizers.

What is claimed as new and desired to be protected is:

1. An optical device, comprising:
a first quarter wave plate;
a half mirror;
a second quarter wave plate, wherein the half mirror is disposed between the first and second quarter wave plates; and
a curved nanowire grid polarizer, wherein the second quarter wave plated is disposed between the half mirror and the curved nanowire grid polarizer, the curved nanowire grid polarizer comprising:
a curved substrate,
a non-regular, substantially periodic array of substantially parallel, elongated nanoridges disposed on the curved substrate and having a wave-ordered structure and being oriented along a first direction, and
an array of metal nanowires disposed on the array of nanoridges

2. The optical device of claim 1, further comprising an image source, wherein the first quarter wave plate is disposed between the image source and the half mirror.

3. The optical device of claim 2, further comprising a polarizer disposed between the image source and the first quarter wave plate.

4. The optical device of claim 1, wherein a period of the substantially periodic array is in a range from 20 to 150 nm.

5. The optical device of claim 1, wherein the nanoridges are formed by pattern transfer from a curved hard nanomask comprising a substantially periodic array of substantially parallel elongated elements having a wavelike cross-section and oriented along the first direction wherein, at least some of the elements of the nanomask have the following structure in cross-section:
an inner region of first material,
a first outer region of a second material covering a first portion of the inner region, wherein the second material is formed by modifying the first material using an ion flow,
wherein the substantially parallel, elongated elements having the wavelike cross-section are formed in a curved layer of the first material deposited on the curved substrate, wherein the first direction is along lines of intersections of a surface of the curved layer with a set of parallel planes and wherein a plane of incidence of the ion flow is substantially perpendicular to the first direction.

6. The optical device of claim 5, wherein the pattern transfer comprises transferring a pattern of the elongated elements on the nanomask to a surface of a curved mold and using the curved mold to form the array of nanoridges of the curved nanowire grid polarizer.

7. The optical device of claim 1, wherein the curved substrate and the substantially periodic array of substantially parallel, elongated nanoridges disposed on the curved substrate are made of optically transparent polymeric material.

8. The optical device of claim 1, wherein the optical device is a virtual reality device.

9. The optical device of claim 1, wherein the half mirror is curved.

10. The optical device of claim 1, wherein the curved nanowire grid polarizer is convex relative to a viewer using the optical device.

11. The optical device of claim 1, wherein the curved nanowire grid polarizer is concave relative to a viewer using the optical device.

12. The optical device of claim 1, wherein the half mirror and the second quarter wave plate are disposed together on a lens.

13. A method of making a curved nanowire grid polarizer for an optical device, the method comprising:
depositing a first material to form a curved surface layer on top of a surface of a curved substrate;
irradiating the surface of the curved surface layer with a flow of ions until a curved hard nanomask is formed, the nanomask comprising a substantially periodic array of substantially parallel elongated elements having a wavelike cross-section, at least some of the elements having the following structure in cross-section: an inner region of first material, a first outer region of a second material covering a first portion of the inner region, and a second outer region of the second material covering a second portion of the inner region and connecting with the first outer region at a wave crest, wherein the first outer region is substantially thicker than the second outer region, and wherein the second material is formed by modifying the first material by the flow of ions, wherein the elongated elements are oriented along lines of intersections of the curved surface layer with a set of parallel planes, and wherein the flow of ions is arranged so as a local plane of ion incidence is substantially perpendicular to the set of parallel planes and oriented along a local surface normal of the curved surface layer;
transferring a pattern of the elongated elements of the nanomask to a surface of a curved, optically transparent substrate to form a non-regular, substantially periodic array of substantially parallel, elongated nanoridges; and
disposing a metal layer on the nanoridges to form an array of metal nanowires of a curved nanowire grid polarizer.

14. The method of claim 13, wherein transferring a pattern comprises transferring the pattern of the elongated elements on the nanomask to a surface of a curved mold and using the curved mold to form the array of nanoridges of the curved nanowire grid polarizer; and
imprinting an optically transparent polymeric material using the curved mold to form the non-regular, substantially periodic array of substantially parallel, elongated nanoridges.

15. The method of claim 13, wherein the first material is silicon, amorphous silicon, silicon containing 5-15 at % of gold, silicon oxide, gallium arsenide, epitaxial gallium arsenide, gallium aluminum arsenide, epitaxial gallium aluminum arsenide, germanium, or silicon-germanium.

16. The method of claim 13, wherein a thickness of the first outer region is at least 2 nm.

17. The method of claim 13, wherein the elongated elements of the nanomask further comprise a second outer region of the second material covering a second portion of the inner region connected to the first outer region at a wave crest, wherein the first outer region is substantially thicker than the second outer region.

18. The method of claim 17, wherein a thickness of the second outer region is no more than 1.5 nm.

19. The method of claim 13, wherein the second material is silicon nitride, silicon nitride containing 5-15 at % of gold, silicon-germanium nitride, silicon oxide, silicon oxynitride, gallium nitride, gallium oxide, aluminum nitride, aluminum oxide, gallium aluminum nitride, or gallium aluminum oxide.

20. The method of claim 13, wherein the ion flow is N₂⁺, N⁺, NO⁺, NHₘ⁺, O₂⁺, or a mixture of Ar⁺ and N₂⁺.

21. The method of claim 13, wherein a curved mold of the first material is used as the curved layer of the first material deposited on the curved substrate.
